(19) United States
(12) Patent Application Publication
(10) Pub. No.: US 2025/0195992 A1
(43) Pub. Date: Jun. 19, 2025

(54) INTERACTIVE GAME SYSTEM AND KIT

(71) Applicant: Steve Rad, Laguna Niguel, CA (US)

(72) Inventor: Steve Rad, Laguna Niguel, CA (US)

(21) Appl. No.: 18/980,220

(22) Filed: Dec. 13, 2024

Related U.S. Application Data
(62) Division of application No. 63/610,965, filed on Dec. 15, 2023.

(51) Int. Cl. A63F 9/18; A63F 9/24; G06F 3/01

(52) U.S. Cl. CPC A63F 9/183; A63F 9/24; G06F 3/011; A63F 2009/2425; A63F 2009/246; A63F 2250/50

(57) ABSTRACT

A virtual and augmented reality system that includes a kit with a map member, a first printed evidence member, and a first scannable evidence member. The map member includes at least a first phase first image target and a second phase first image target. The system also includes software that is configured to run on a mobile device that includes a camera. The software is in communication with a target database and includes first phase first linked augmented reality content and first phase first linked virtual reality content that is associated with the first phase first image target. The first phase first linked virtual reality content includes a first phase first video clue. The software includes second phase first linked augmented reality content and second phase first linked virtual reality content that is associated with the second phase first image target. The second phase first linked virtual reality content includes a second phase first video clue.

### CROSS-REFERENCE TO RELATED APPLICATIONS

This application claims the benefit of U.S. Provisional Application No. 63/610,965, filed on Dec. 15, 2023, which is incorporated by reference herein in its entirety.

### FIELD OF THE INVENTION

The present invention relates generally to an interactive crime solving game system and kit where a user to performs a series of actions using a printed media member or map, associated software application and associated instruments or evidence.

### BACKGROUND OF THE INVENTION

True crime series, games and interest have become increasingly popular in recent years. The present invention provides a system, method and kit for a true crime related game that includes augmented and/or virtual reality elements. 6361

### SUMMARY OF THE PREFERRED EMBODIMENTS

In accordance with an aspect of the invention there is provided a method of participating in a game play experience that includes a plurality of phases to reach an objective. The method includes obtaining a kit that includes a map member and a first phase first printed evidence member. The kit has a theme and the map member includes at least a first phase first image target that includes first phase first linked augmented reality content and first phase first linked virtual reality content. The method includes obtaining a mobile device that includes software running thereon that is in communication with a target database. The first phase first linked augmented reality content and the first phase first linked virtual reality content are associated with the software. The mobile device includes a camera that has a camera lens and the first phase first linked augmented reality content and the first phase first linked virtual reality content is related to the first phase. The method includes beginning the first phase and orienting the mobile device such that the camera lens is directed toward the map member. When the first phase first image target is recognized by the software, the first phase first linked augmented reality content is displayed on the mobile device and then the first phase first linked virtual reality content is displayed on the mobile device. The method includes viewing the first phase first linked augmented reality content followed by the first phase first linked virtual reality content on a screen of the mobile device. The first phase first linked virtual reality content includes a first phase first video clue. The method includes entering the first phase first video clue into a text prompt box related to the software. The game play experience advances to the second phase of the plurality of phases (if the first phase first video clue is correct). The first phase first printed evidence member may includes a first phase first printed clue the method may include entering the first phase first video clue and the first phase first printed clue into the text prompt box (could be at separate times). The game play experience advances to the second phase of the plurality of phases.

The map member may include a second phase first image target that includes second phase first linked augmented reality content and second phase first linked virtual reality content. The second phase first image target is not recognized by the software during the first phase. In other words, during the first phase, the second phase first image target (or any second phase image targets do not render augmented reality content (until the user moves to the second phase). The method may also include orienting the mobile device such that the camera lens is directed toward the map member, where the second phase first image target is recognized by the software and the second phase first linked augmented reality content is displayed on the mobile device and then the second phase first linked virtual reality content is displayed on the mobile device. The kit may include a second phase first scannable evidence member and the method may include orienting the mobile device such that the camera lens is directed toward the second phase first scannable evidence member. If the second phase first scannable evidence member is correct (is recognized by the software or target database), the game play experience advances to a third phase of the plurality of phases.

The map member may include a scope member image target that includes scope member linked augmented reality content that shows a scope member on the screen of the mobile device. The method may include positioning the scope member on the first phase first linked augmented reality content and after the scope member has been positioned on the first linked augmented reality content for a predetermined period of time, the first phase first linked virtual reality content is displayed on the screen of the mobile device.

In accordance with another aspect of the invention there is provided a virtual and augmented reality system that includes a kit with a map member, at least a first printed evidence member, and at least a first scannable evidence member. The map member includes at least a first phase first image target and a second phase first image target. The system also includes software that is configured to run on a mobile device that includes a camera that has a camera lens. The software is in communication with a target database and includes first phase first linked augmented reality content that is associated with the first phase first image target and first phase first linked virtual reality content that is associated with the first phase first image target. The first phase first linked virtual reality content includes a first phase first video clue. The software includes second phase first linked augmented reality content that is associated with the second phase first image target and second phase first linked virtual reality content that is associated with the second phase first image target. The second phase first linked virtual reality content includes a second phase first video clue.

The first printed evidence member includes a second phase first printed clue. Third phase first linked augmented reality content and third phase first linked virtual reality content may only accessible after entering the second phase first printed clue into a text prompt box related to the software. Third phase first linked augmented reality content and the third phase first linked virtual reality content may only accessible after scanning the first scannable evidence member using the camera.

The present invention is a gameplay experience (or game, for short) that involves the solving of a fictious crime. The game includes a plurality of phases that the user must advance through to reach the objective (i.e., solving the crime). For example, the crime may be a murder and the objective as determining the name of the killer. To advance through the phases of the game, the user may review evidence members and videos and/or scan evidence members. The evidence members and videos may include or be a clue. A clue may be printed on an evidence member (e.g., a phone number) or may be evident in a video (e.g., the clue may be some words in the video). The entry of the clues into a text prompt box in the app may allow the user to proceed to the next phase. The scanning of the correct evidence member may also allow a user to proceed to the next phase. A phase may require multiple clues to be entered or evidence members to be scanned to move to the next phase.

The present invention provides a virtual and/or augmented reality experience, game and system related to solving a crime. U.S. Patent Publication No. 2020/0184223, filed Jun. 11, 2020 (the “'223 publication”), is incorporated herein by reference in its entirety.

In a preferred embodiment, the present invention includes several steps or phases within a game that may be associated with solving a crime, such as a murder, and wherein one or more of the steps may include the use of augmented or virtual reality (which may be referred to generally herein as VR). The VR element or step may include videos that show a suspect or other person associated with the crime or scenario. The video footage, for example, may appear to be closed circuit television (CCTV) camera footage that provides video clues to solving the case. In a VR video, a user may view the video captured by the associated camera, and which, may have been created using actors to portray a crime. For example, the user may see footage of what took place in an elevator (e.g., to see who a suspect was with), a police dash cam, a diner or restaurant (to see what a suspect or person ate), a parking lot camera etc.

During use, the app may prompt the user with questions or objectives (text, video, audio, etc.), in which they must scan instruments, items and/or evidence (which are part of the documents provided in the set or kit) into “evidence” or into the app or software. Similar to scanning a check for deposit with a banking app. The user may also be prompted to enter answers into the app to advance to the next phase or step in the process. In an exemplary embodiment, objective or step in the gameplay of solving a crime may be prove Mr. Jones was not the killer and exonerate him so that you can focus on finding the killer. The user then reads through the materials to try and learn and uncover details. Then the user accesses the VR/AR surveillance using the map and the image targets based on some of the locations. A predetermined number of videos or image targets may be available or usable during step one and then further videos may become available as the user moves to further steps (e.g., only 4 videos available in step 1 and more are unlocked or available as the user progresses to steps two, three and beyond). For example, there may be ten total image targets on the map that prompt or start a video, but only three are available during step one. The user may then scan (using the app) the document(s) that they believe prove Mr. Jones is innocent. For example, the proper evidence may be a newspaper article that says the bridge was closed that night and it would have been impossible for Mr. Jones to be at the scene, etc. Upon the app accepting the scanned evidence, objective or step two is unlocked or the user may proceed to the next step until a later objective or step is “identify the killer.”

In a preferred embodiment, the gameplay, app, etc. also includes content that may be accessible via social media or other internet based website. For example, the user may be instructed to access or attempt to access social media accounts, icloud accounts, email accounts, LinkedIn, etc, for example, to create a narrative around the victim, suspect or others associated with the crime or situation as if they were a real person. Part of the game may include “hacking” into an email account to read through their messages and history, which may unlock another clue or lead to another object or step.

In a preferred embodiment, the present invention includes the viewing of the videos or CCTV videos that are accessed via VR and that play a key role in providing clues and evidence to the victims, suspects and other people's behavior, whereabouts and other aspects, and an app led platform that asks or prompts the user to solve the case by providing and “scanning into evidence” (using the camera on the user's mobile phone or tablet) the documents that they believe can help crack the case and thus lead to the next step or objective during the process. The app and/or website may ask the user to enter answers online into the app or website and the app or website provides a yes or a no regarding whether the scanned or entered evidence is proper or correct. Hints may be offered.

Preferably, the kit may include all the evidence, instruments, materials, map, etc. and the goggles. Titles may include, for example, “The Murder of Angela Brown,” “The Missing Freshman Track Star,” etc. The evidence members may include witness statements, interview transcripts, pictures of witnesses, police report(s), autopsy report, newspaper clippings, individual pieces of evidence, such as happy hour flyer for bar, flyers/advertisements (e.g., for specific business locations that may be associated with the map), utility invoices, phone records, business or restaurant receipts, parking stubs, tickets, drink coasters, etc., letters, e.g., letters from persons related to the victim, suspect(s) or other person, ballistic report, bank statements, case notes, hand written note, phone bills, power bill and screenshots or pictures from the crime scene. The kit may include a plurality of witness or suspect files. Each witness or suspect file may include one or more pictures, information about the witness, fingerprints, interview transcriptions or further information. All or some of these different types of evidence members may include information related to the solving of the crime or the completion of the phases to reach the objective and the information may be entered into the app via a text prompt box or via scanning. The system, method or process includes a predetermined number of steps or phases (e.g., four) to reach the final objective (e.g., solve the crime and determine who is the guilty suspect or person).

In a preferred embodiment, the present invention includes one or more of a kit and system that includes at least one or more books, sheets, maps or other printed media members, virtual or augmented reality (“VR”) goggles or an eye piece for holding a mobile phone or the like that acts as VR or AR goggles, a set of instruments and a software application (“app”). Generally, a user downloads the app to their mobile device/smartphone, tablet or the like, opens the book, map member or printed media member and participates and utilizes the mobile device both with or without the goggles to participate in an augmented reality (“AR”) and/or VR experience where the app recognizes targets on the pages of the book. It will be appreciated that, in a preferred embodiment, the goggles are not actually VR goggles, meaning they do not include VR capability built in to the goggles. Instead, the goggles (helmet or other head mounted device) include the ability to secure a smartphone or other portable electronic device therein. The app can also have the capability of not showing the video in split screen mode so that it can be viewed directly on the screen of the phone and without having to use goggles. However, use without the goggles in watching a video is still considered a VR experience in the scope of the invention as moving the phone around allows the viewer to see different parts of the scene (as if they were looking around by moving their head) because the videos of shot or filmed so they can be viewed in this manner. Similarly, for the AR experience, where the user views the map member through the phone's camera and on the screen, the goggles may or may not be used. However, the buildings or locations on the map member that have a video associated with them (i.e., an image target) become a three dimensional looking building in AR mode that when the cursor or scope member is positioned over the building will start a video (or after a predetermined period of time). The map member may be embodied in any printed media form. For example, the map member may be a foldable piece of paper, a book, a pamphlet, etc. and may have multiple pages.

Generally, target-based augmented reality devices (“AR device”) allow users to view information linked to image targets identified by the devices in real time. In the present invention, the AR or VR device is a mobile device, which may be a smart phone (e.g., iPhone, Google phone, or other phones running Android, Windows Mobile, or other operating systems), a tablet computer (e.g., iPad, Galaxy), personal digital assistant (PDA), a notebook computer, or various other types of wireless or wired computing devices, that includes associated software running thereon (typically in the form of an app). As described herein, the AR device is coupled or paired with the goggles or other head mounted device so that the user can view the content on the screen of the AR device and be provided a simultaneous real-world view. The mobile device (AR device) together with the goggles (head mounted device) are referred to herein as the AR assembly.

As discussed above, the VR goggles are used for an AR experience and can also be used for a VR experience. In an exemplary embodiment of the invention, the AR experience involves an educational chemistry or science lesson or lessons that takes place on the pages of the book. However, this is not a limitation on the present invention. Throughout the specification and drawings the exemplary kit and systems are part of Cold Case VR. However, this is only used as an example, and the principles of the present invention can be used for other projects, lessons and the like.

The experience or game play is related or directed to the user(s) attempting to solve a crime based on a case file or cold case file. The “file” that is provided to the user may include instruments, such as maps, person profiles, videos, evidence, letters, notes, testimony and the like. The items or instruments may come in a box that looks like an evidence box or file that someone might see in a police station.

In accordance with a first aspect of the present invention there is provided a method of participating in an augmented reality experience that includes obtaining or providing a printed media or map member that includes at least a first image target that includes first linked augmented reality content, obtaining or providing a head mounted device that includes a mobile device securing member, obtaining or providing a mobile device with a camera that has a camera lens that includes software running thereon that is in communication with a target database, securing the mobile device in the head mounted device using the mobile device securing member, and orienting the mobile device such that the camera lens is directed toward the printed media member. When the first image target is recognized by the software the first linked augmented reality content is displayed on the mobile device. The method also includes viewing the first linked augmented reality content through the head mounted device.

Preferably, the printed media member includes one or more pages that include image targets, such as a first image target that is disposed on the first page and a second image target that includes second linked augmented reality content. The printed media member can include any number of pages and/or any number of image targets.

In a preferred embodiment, the printed media member and head mounted device are part of a kit and the method includes the step of obtaining at least a first instrument that is part of the kit. The first linked augmented reality content includes audio that directs a user to utilize the first instrument. Preferably, the method also includes obtaining or providing at least a second instrument that is not part of the kit and the first linked augmented reality content includes audio that directs a user to utilize the second instrument. In a preferred embodiment, the method includes the step of obtaining at least a first instrument that is part of the kit and the first linked augmented reality content includes audio that directs a user to utilize the first instrument. The method may include obtaining or providing at least a second instrument that is not part of the kit and the second linked augmented reality content includes audio that directs a user to utilize the second instrument. In other words, the use of the instruments whether they are part of the kit or not may be associated with one or more image targets and the augmented reality content associated therewith.

In a preferred embodiment, the first linked augmented reality content is one of three-dimensional type augmented reality content or two-dimensional type augmented reality content. The two-dimensional type augmented reality content may augment within a frame located on the printed media member. The frame may not be an actual visible frame. However, the video appears to play within a certain space on the page. In a preferred embodiment, the first linked augmented reality content is three-dimensional type augmented reality content and the second linked augmented reality content is two-dimensional type augmented reality content that augments within a frame located on the printed media member.

In accordance with another aspect of the present invention there is provided an augmented reality system that includes a printed media member that has at least a first image target, a head mounted device that includes a mobile device securing member, and software that is configured to run on a mobile device that includes a camera that has a camera lens. The software is in communication with a target database (either on a remote server or within the software) that includes information related to the first image target, and wherein the software includes first augmented reality content that is associated with the first image target.

In a preferred embodiment, the printed media member and head mounted device are part of a kit that also includes at least first and second instruments. The first augmented reality content may include audio or video instructions related to tasks, such as a first task that includes use of the first instrument. The first augmented reality content may also include audio instructions regarding a second task that includes the use of a third instrument that is not part of the kit. In a preferred embodiment, the printed media member includes a second image target, the target database includes information related to the second image target, and second augmented reality content that is associated with the second image target is part of the software. Preferably, the second augmented reality content includes audio instructions regarding a third task that includes use of the second instrument.

In a preferred embodiment, the first augmented reality content includes video related to the first task that augments within a frame located on the printed media member. Preferably, the video includes a demonstration using the first instrument. It will be appreciated that the first instrument is not the exact same instrument that came with the kit, but is the same type of instrument.

In use, the Cold Case VR app is launched. The user then cycles through the steps on the smartphone. During some steps the user follows prompts on the screen of the smartphone and during other steps the user may be prompted or instructed to place the smartphone into the goggles. For example, once the map or other printed media member is opened and the user “looks at” the page through the goggles and the app, via the camera, the app recognizes via scanning an AR target on the page and the app renders or augments the video or AR content on the screen of the smartphone (or other AR device). For example, when an image target on the map that is associated with a video is recognized, the video may be played on the smartphone such that the user experiences the video through the googles. The video may appear like a closed circuit television (CCR) video that provides the user with clues in solving the cold case. For example, the video may show the user who murder victim was spending time with the prior to the murder or the location(s) of the murder victim and/or suspects at a particular time.

As different AR targets are scanned and recognized, different AR content is rendered or augmented. For example, when the second target is recognized, the second AR content may be two suspects in an elevator discussing details related to the crime. In other words, the app scans/reads the page in front of the user and triggers the videos. In a preferred embodiment, the passive scanning allows users to be relieved of the need to actively search for the AR targets. Instead, as soon as a target is scanned the AR content is augmented and displayed on the smartphone screen and viewed by the user through the goggles. Augmented reality target detection is taught in U.S. Pat. No. 9,401,048, the entirety of which is incorporated herein by reference.

As discussed above, the user may also be prompted to scan different instruments, items or pieces of evidence into the smartphone or app, using the camera in order to complete a step in the process of solving the crime. The app may provide instructions regarding what is needed to move to the next step or to complete a goal. For example, given a set of 10 different suspects and a file for each (which are provided with the kit), the user may be required to scan or upload the 2 most likely suspects and, until they have done so or during the process, the game or experience may not move to the next step. Some of the instruments necessary for the project can be provided by the user.

Generally, the goggles include a hollow main body portion and a holder, clamp or support member that is spaced from the main body portion define a phone slot therebetween for mounting a smartphone therein. Preferably, the goggles also include lenses, and a strap, or other component for securing the goggles to the user's head.

The present invention includes a method of using the software application to scan a printed media member that includes at least a first image target that includes first linked video content, viewing the video content, scanning predetermined instruments or evidence using the mobile device, wherein the application advances to the next step if the scanned instrument or evidence is the correct predetermined instrument or evidence.

### BRIEF DESCRIPTION OF THE DRAWINGS

FIG. 1 is a schematic view of a number of components of a kit for the system of the present invention;

FIG. 2 is an elevational view of a mobile device that includes an app icon thereon that associated with the system;

FIG. 3 is a view of a map member;

FIG. 4 is an example of several first linked augmented reality content being displayed on the screen of a mobile device;

FIG. 5 is an example of several first linked augmented reality content being displayed on the screen of a mobile device along with a scope member with a circular bar showing linked virtual reality content being loaded;

FIG. 6 is a video or virtual reality content being played and displayed on a screen of a mobile device;

FIG. 7 is an exemplary view of a mobile device that includes a portion of the software application thereon and preparing to scan evidence;

FIG. 8 is an exemplary view of a mobile device that includes a portion of the software application thereon and including a text prompt box.

FIG. 9 is a block diagram showing the augmented reality system in communication through a network with a remote target database; and

FIG. 10 is a block diagram of a computer system suitable for implementing one or more components discussed herein.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

The detailed description provides explanations by way of exemplary embodiments. It is to be understood that other embodiments may be used having mechanical and electrical changes that incorporate the scope of the present invention without departing from the spirit of the invention.

While certain embodiments of the present invention are described in detail above, the scope of the invention is not to be considered limited by such disclosure, and modifications are possible without departing from the spirit of the invention as evidenced by the following claims.

Referring now to the drawings, wherein the showings are for purposes of illustrating the present invention and not for purposes of limiting the same, the drawings show components of an augmented reality system, at least a portion of which, can be provided to users in a kit 10 in accordance with preferred embodiments of the present invention.

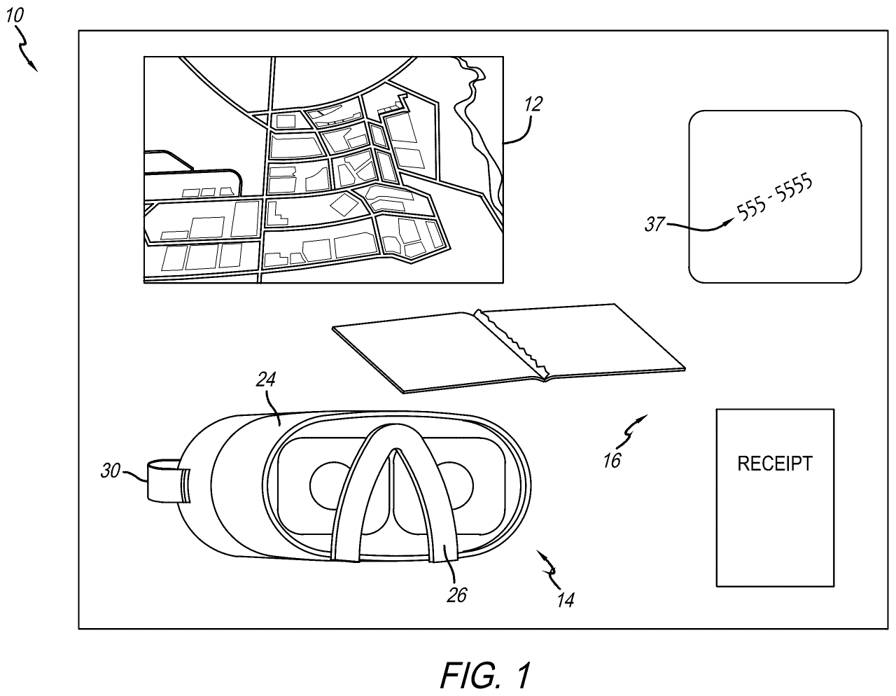

As shown in FIG. 1, in a preferred embodiment, the kit 10 may include one or more printed media or map members 12, a head mounted device 14 and a plurality of instruments or evidence members 16 that can be used during the game play experience described herein. The map members 12 can be, for example, a book, poster, brochure, foldable sheet, or other printed media member, etc. The printed media or map member 12 can also be a pdf or other electronic file that is viewable on a computer screen. The head mounted device 14 can be any device that is capable of being mounted on a user's head and securing a mobile device thereto. In a preferred embodiment, the head mounted device 14 is a pair of goggles, but could also be a helmet, headband or other head mounted device. For example, the kit 10 can be provided in a box that includes the goggles, map member 12, instruments and evidence members 16, such as business cards, plane tickets, fingerprint cards, etc. FIG. 1 shows a receipt, a drink coaster with a phone number thereon and a coupon book with one of the coupon's missing or torn out. Other examples of instruments, evidence or printed media members may include one or more business cards, plane tickets, sticky notes, stamps, gift cards, rewards cards, evidence bags, etc.

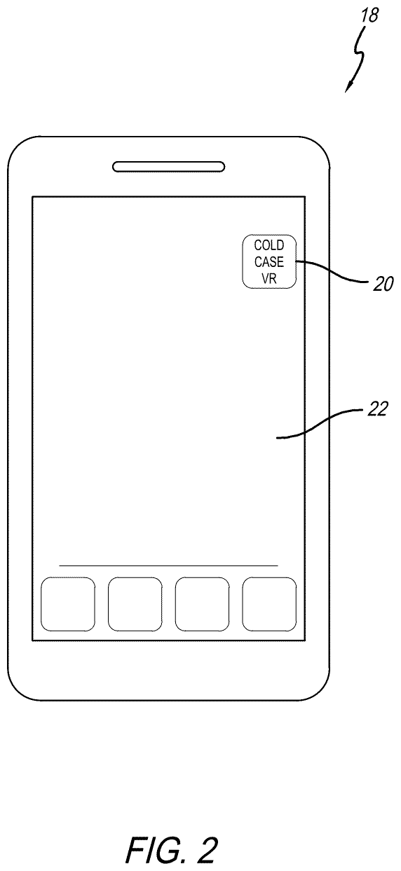

As discussed herein, in a preferred embodiment, the present invention includes software that can be downloaded to a mobile device 18 in the form of an app. FIG. 2 shows a mobile device 18 with an exemplary app icon 20 thereon that is associated with the software program. In use, the mobile device 18 may be secured to the head mounted device 14 so that the screen 22 of the mobile device 18 is viewable by the user when the head mounted device 14 is placed on the user's head. In a preferred embodiment, the head mounted device 14 includes a main body portion 24, a securing member 26 and a strap 30. It will be appreciated that the securing member can be any component that secures the mobile device to the head mounted device. For example, the securing member can be a strap, elastic band or the like and can include Velcro, snaps, tabs or other components for securing the mobile device. When properly positioned in the head mounted device 14, the camera opening or lens 34 of the mobile device 18 is exposed so that it can view the map member 12, as discussed below.

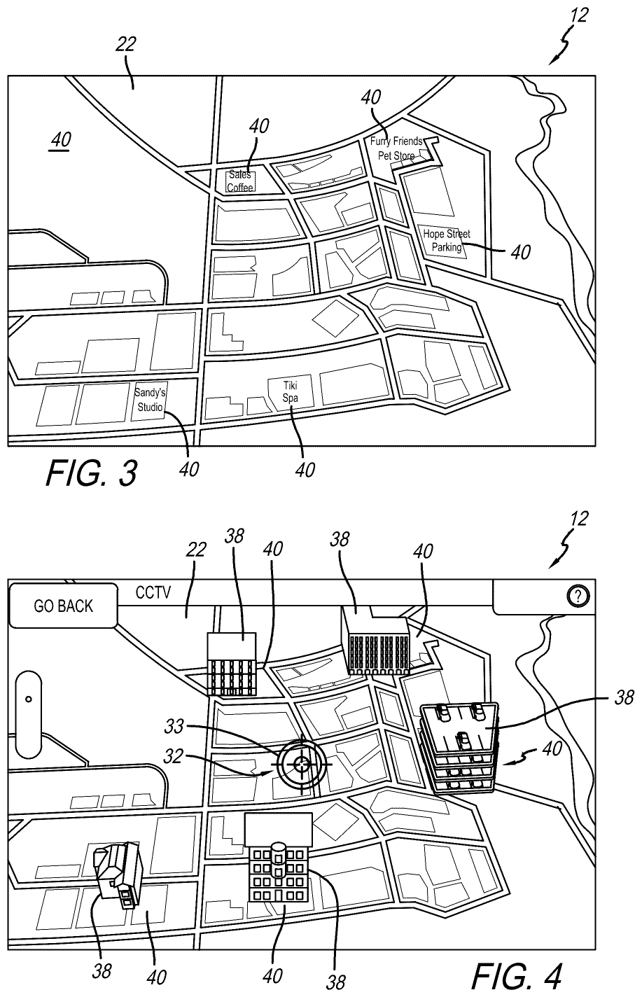

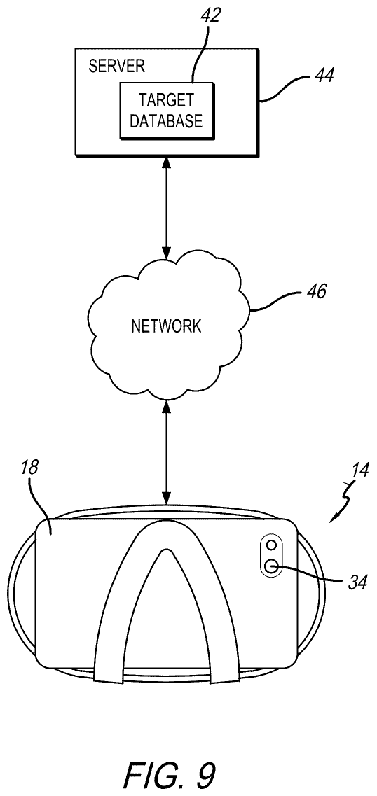

FIG. 3 shows an exemplary printed media member 12 that is embodied as a map. In a preferred embodiment, the printed media member 12 includes at least first and preferably a plurality of image targets 40. FIG. 3 includes five image targets 40 labeled as Sandy's Studio, Sales Coffee, Furry Friends Pet Store, Hope Street Parking and Tiki Spa. It will be appreciated that any of the evidence or instruments may also be a printed media member and include image targets that are recognized by the software and, as a result of being recognized, prompt or cause certain actions to take place. As shown in FIG. 9, the system includes a target database 42. In a preferred embodiment, the target database 42 is part of or associated with the software program downloaded to the mobile device 18. However, in another embodiment, the target database 42 can be stored on a remote server 44 or the like that is accessible via a network 46, such as the internet.

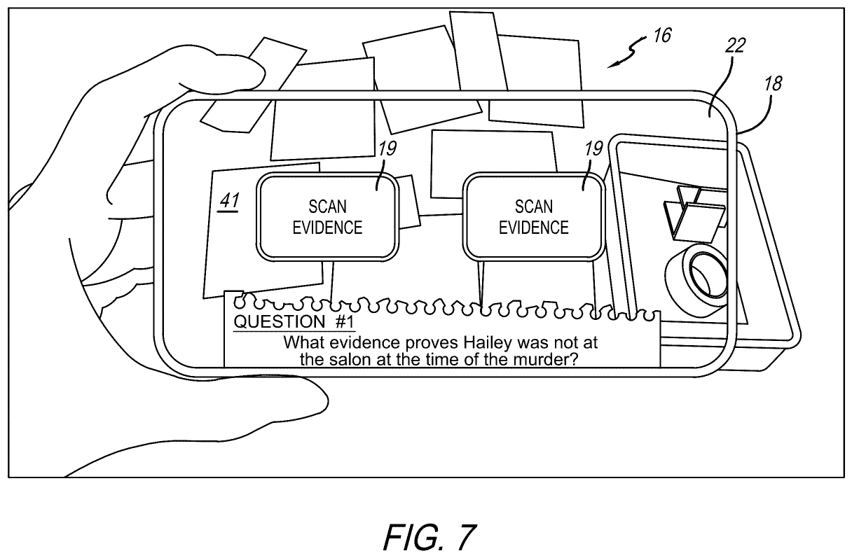

Each image target 40 includes or is associated with augmented reality content, virtual reality content or video content linked thereto or associated therewith. As will be appreciated by those of ordinary skill in the art, the image targets can also be any of the printed material (e.g. evidence members) that is recognized by the software, see, for example, FIG. 7. The image target (or scannable evidence member) may also be the entire image, instrument, evidence or page. In use, when viewing the screen 22 while directing the camera toward the map member 12, the image targets 40 cause linked augmented reality, virtual reality or video content to be augmented, displayed, activated or sounded. In use, when an image target 40 is recognized the associated augmented and/or virtual reality and/or video content is displayed on the screen. FIG. 4 shows augmented reality content 38 that looks 3D when viewed. The augmented reality content 38 that is generated the image target in FIG. 4 are buildings that appear to “pop up” on the map member 12.

FIGS. 4-7 include exemplary screen representations of using the mobile device during the steps or gameplay. In FIG. 7, the software, screen or app includes one or more buttons 19 that can be selected so that the user may scan in evidence 16 (which may be or include or be an image target 40). After scanning, the software determines whether the proper evidence member(s) 16 that allow the user to answer the question correctly or move to the next phase have been scanned. This type of evidence member may be referred to herein as a scannable evidence member 41. The image targets can be a particular image, picture, drawing, word or set of words or other recognizable target on the scannable evidence member. For example, in FIG. 7, the screen 22 includes the question “What evidence proves Hailey was not at the salon at the time of the murder?” In use, based on a review of the evidence the correct scannable evidence member may be a receipt with a time stamp on it showing that she was at another location at the time of the murder. Other pieces of evidence or evidence may not be recognized by the software (e.g., they may not be included in the image or target database. In another embodiment, all of the evidence members in the kit may be included in the target database, but only the correct answers allow the user to progress in the gameplay. In another step the user may need to scan two evidence members 16 (e.g., a phone bill and a business card) showing that one of the suspects in the case was not present at a location at the time of the murder. It will be appreciated that by only including two opportunities to scan in evidence, this prevents the user from just scanning everything. The user cannot proceed to the next question or phase until the two proper pieces of evidence have been scanned.

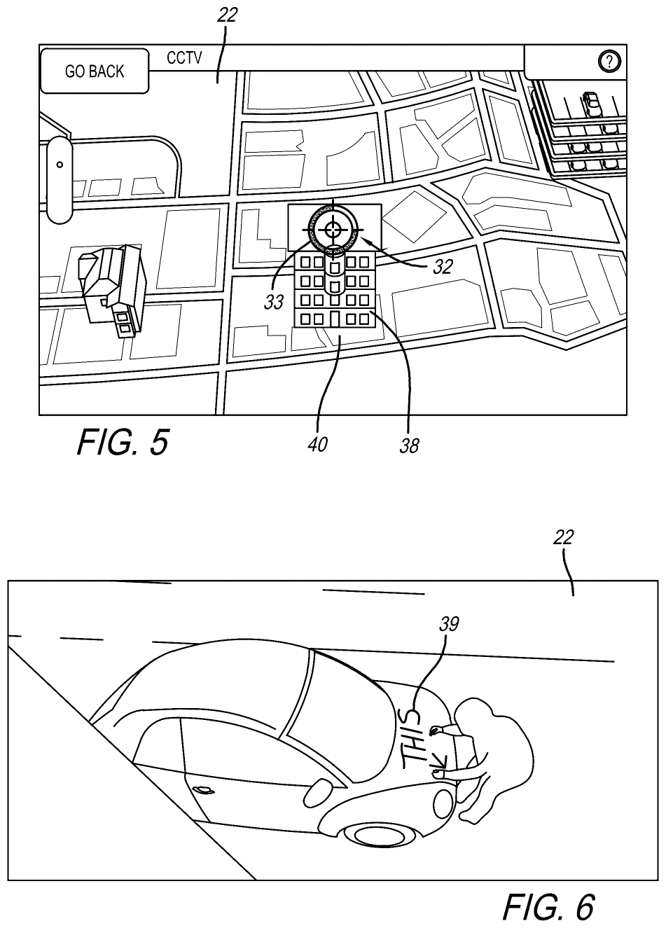

FIG. 4 includes a scope member 32 that allows the user to determine which of the image targets 40 or augmented reality content 38 “buildings” or “locations” they want to learn more about. The scope member 32 is rendered or shown only when the user directs the mobile device toward the map member 12. In other words, the map member 12 includes or is an image target that causes the scope member 32 to be rendered as augmented reality content. Each of the image targets 40 or augmented reality content 38 on the map member 12 includes a video associated therewith that can be viewed on the phone. When the user directs the scope member 32 toward the image target 40 or augmented reality content 38 and maintains the scope member 32 in position for a predetermined period of time (e.g., four seconds) over the associated image target 40 or augmented reality content 38, the video appears on the screen and is played. Four seconds is used as an example herein for the predetermined period of a time that a user has to maintain the scope member 32 over the image target 40 or augmented reality content 38 building for the software to be prompted to play the associated video on the screen. FIG. 4 shows the scope member 32 with a status bar 33 (in the form of a circle in this example) that is empty because it is not positioned over any of the augmented reality content 38 buildings. FIG. 5 shows the scope member 32 positioned over the Tiki Spa (see FIG. 3) and the status bar 33 is three quarters filled in. In this example, the user has held the scope member 32 over the Tiki Spa building augmented reality content for three seconds. Once the status bar 33 fills in (four seconds have elapsed), a video appears on the screen. FIG. 6 shows an exemplary screen grab from a video that was rendered based on the Tiki Spa image target and/or augmented reality content. A different video is associated with and played for each of the locations on the map member 12 as the associated image target is recognized. As used herein, the type of augmented reality associated with the locations on the map member and the like is referred to as three-dimensional type augmented reality content because the content appears three-dimensional to the user, as shown in FIGS. 4 and 5.

The videos associated with each location may include information or clues associated with the crime or overall gameplay and that may be used for answering questions or scanning evidence to move to the next phase and ultimately, the objective. Referred to herein as video clues. The video clues may be text or words (e.g., as shown in FIG. 6) or may be other clues associated with the video. The clues may also be audio within the video. Furthermore, the information within one or more videos may lead the user to one of the evidence members or to an online location, such as a website, etc. where the actual video clue answer is located. For example, a video may include someone talking about a local business and their website (e.g., free-glo.com) and the answer that is entered into the text prompt box may be on the website (e.g., a person's name). Entry of the person's name into the text prompt box allows the user to proceed to the next phase. Within the scope of this invention, the answer is considered a video clue because information that led to the user being able to move to the next phase was found in a video. For example, the question to move to the next phase may be “on what floor did Ethan exit the elevator?” “What color was the suspect's hat?” “Who is darkstar90?”

It will be appreciated that the videos may be created such that they are virtual reality content. As described herein, the augmented reality content can be viewed by the user (through the goggles or on their mobile device), but the user can also see the map member (and other things therearound) as captured by the camera of the mobile device. Therefore, the augmented reality content appears on the map member (or other printed media members associated with the gameplay). However, in a virtual reality experience the camera of the mobile device is not activated and the user cannot see the printed media member any longer. Instead, the content that is rendered is a virtual reality video where the user is immersed therein. For example, in the video from the screengrab in FIG. 6, a suspect is writing on the hood of a car. In the video, the person walks out of the Tiki Spa and to the car and then writes on the hood. The information on the hood may be the answer to a question to move to the next phase (referred to herein as a video clue 39). The correct answer to a question that is present in a video and that us used to be entered in a text prompt box 35 to correctly answer a question and progress or at least partially progress the game to the subsequent phase is referred to as a video clue. The video(s) may be an animated video or can be an actual video that has been filmed for the gameplay. And, because the video is filmed or created as a virtual reality video, when the user turns their head to “look around” (if wearing the goggles) or moves their phone (if just viewing on the screen of the phone), the user sees a different perspective within the site where the video takes place (e.g., outside the Tiki Spa). The videos may be non-virtual reality as well. The use of the term virtual reality herein, and in the claims, does not mean that the videos have to be virtual reality, the videos may be traditional videos displayed on the screen that do not change perspective when the user moves the phone or changes the angle.

As discussed herein, the type of augmented reality associated with the buildings appearing in 3D on the map member and the like is referred to as three-dimensional type augmented reality content because the content appears three-dimensional to the user, as shown in FIG. 4, and the content associated with the image targets that activate a full screen video is referred to as virtual reality content. The image targets 40 on the map member 12 include both three-dimensional type augmented reality content 38 and virtual reality content. All of the different three-dimensional type augmented reality contents 38 from the associated image targets 40 render on the screen, as shown in FIG. 4. However, the virtual reality content associated with an image target 40 only renders or appears on the phone screen after the scope member 32 has been positioned over the image target 40 for a predetermined period of time.

In use or during gameplay, the user(s) progress through a series of steps or phases, each of which must be completed in order until the user(s) reach the final objective, solve the crime or finish the game. Similar to real crime solving, the user(s) must survey and review the evidence members, documents and other materials provided in the kit to determine the proper pieces of evidence that lead to solving the crime. The user must scan the proper pieces of evidence so that they continue to the next step.

As discussed above, in a preferred embodiment, the kit includes instruments or printed media members. The evidence members and map member(s) are associated with the theme of the kit, e.g., crime. An example will be provided using the Cold Case VR. After opening the app (activating the software), the app may include introductory information, evidence or description that starts the crime solving game, such as information related to the victim, possible suspects, locations, etc. The first piece of evidence or instrument may be a letter related to the victim (e.g., from the victim's mother to the detective) that provides information to begin the game. A letter from the cops or detectives or exemplary notes from the victim's family member and detective (inspector) may also be included to provide information to the user(s).

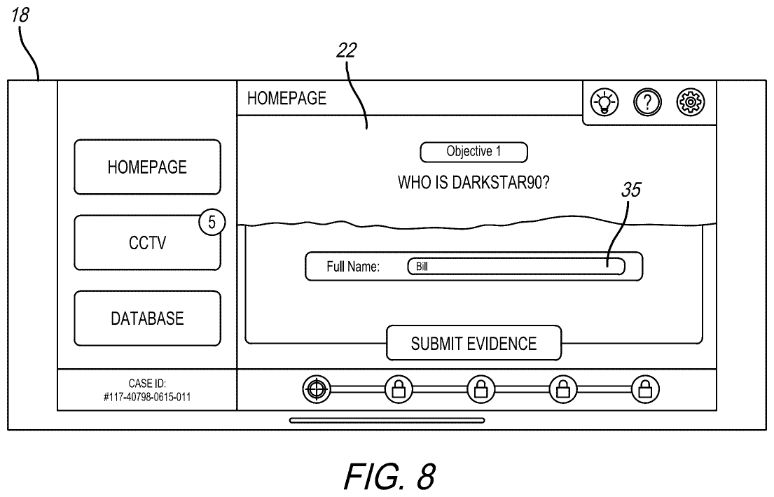

Next, the user may be prompted to review the map member 12. The user may scan an image target on the map to begin and watch a first video or virtual reality content. When the image target 40 is recognized by the software via the camera and camera lens on the mobile device a video may be rendered on the screen showing the user. The video may be related to the location on the map. For example, if the location on the map is an apartment building, the video may be a scene that takes place in an elevator in the apartment building. The video, for example, may show a suspect in the elevator at the time of the crime, thus showing that that particular suspect is not the murderer or which floor the victim exited the elevator, what apartment she then went into or other relevant information. The app may then include one or more questions that he user must answer to progress to the next step or phase. For example, the user may be asked “identify who the victim was with on Friday night?” or “prove that Eric was not at the crime site when the murder occurred.” The answer may be provided by scanning in the proper evidence member 16, as shown in FIG. 7 or by typing in an answer, as shown in FIG. 8. Once the proper answer is provided, e.g., the user progresses to the next step or phase.

FIG. 8 shows an exemplary screen in the app where the user answers a question by entering text in the form of an answer in a text prompt box 35. A “submit evidence” button is included so that once the user has provided their answer, the app informs the user if the answer was correct or not. If the answer is correct, they may move to the next phase. Each phase may include a predetermined number of questions that must be answered correctly or a predetermined number of evidence members that must be scanned in correctly or a combination of both.

If the user has not progressed to the next phase yet they may go back to the map member and use the scope member 32 to render a second video. The next video may show, for example, the second location on the map and image target may be associated with a video showing that the victim was at an autobody shop to change her tires that afternoon. The virtual reality footage may allow the user to “look around” by orienting the mobile device (either in the goggles or not) and seeing different areas within the autobody shop. The video or other information on the screen may provide any details regarding the next steps (e.g., answers to questions) in solving the crime. The video may appear to be in the form of CCTV footage from a camera in the elevator, for example. The video viewed directly on the mobile device or using the goggles. The user may then be prompted with another question and be required to scan in a predetermined number of proper pieces of evidence members or answer questions to move to the next phase. The app may inform the user that one answer is correct and the other is incorrect.

Once the user moves to the next phase (e.g., the second phase), the user may then be prompted to view the map member 12 again. In the second or subsequent phase, the map member 12 may include new or second phase image targets 40 that are now recognizable by the software and that render new or second phase augmented reality content 38. This may include one or new locations on the map that did not include augmented reality content during the first phase.

During play there may be a first or predetermined amount of image targets 40 on the map that are active during any step in the gameplay. For example, there may only be two at the beginning, and by viewing both videos associated with the image targets, this may provide enough information for the user and that particular step or phase. As play or the steps progress, further image targets on the map 12 may be added or activated.

The present invention may also include clues, information or prompts either from the evidence or on the screen that instructs or prompts the user to go to a website or other online location (e.g., social media app) to log in to an email account, social media account, etc. that is part of the gameplay. For example, the user may find a sticky note with a password written on it together with a web address (that may also be located on another piece of evidence) and the user may then go to coldcasevremail.com and log in to the email account using the password. The email account may contain a clue or information to complete a step. This type of evidence may be referred to herein as “web evidence”. The app may provide hints. All of the steps to progress to the next step or phase may take place within the app. At least some of these steps are completed via an input, such as scanning the proper piece of evidence or inputting an information, such an answer to a question, using the app.

In an embodiment of the invention, the AR aspects of the invention, such as the image targets on the map may be omitted and only the VR videos are included. The VR videos (e.g., the CCTV style videos) may be accessed via the app instead of using the camera to find an image target on the map or other printed media member. The claims included in any application related hereto may include this feature and may start without the inclusion of the need for a map or printed media member, and/or the scanning of evidence, etc.

It will be appreciated by those of skill in the art that any type of computer can be used with the present invention. Generally, the invention includes a software application running on a device 18, which may or may not be in communication with a server 44 via a network 46. Network 46 may be implemented as a single network or a combination of multiple networks. For example, in various embodiments, network 46 may include the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. As such, in various embodiments, computing device 18 may be associated with a particular link (e.g., a link, such as a URL (Uniform Resource Locator) to an IP (Internet Protocol) address). In one or more embodiments, mobile device 18 may use the remote target database 42 or may transmit the images to a remote server for image target identification.

In a preferred embodiment, the participating in the game play experience includes a plurality of phases (e.g., first, second, third, etc. phases) to reach an objective (e.g., solving the crime and/or correctly finding the killer). The game play experience includes obtaining the kit 10 that may include a map member 12 and one or more first phase first printed evidence members 16. The kit has a theme (e.g., solving a murder) and the map member 12 includes one or more first phase first image targets 40 that include first phase first linked augmented reality content and first phase first linked virtual reality content. The method also includes obtaining or using a mobile device that includes software running thereon that is in communication with the target database 42. The first phase first linked augmented reality content and the first phase first linked virtual reality content is associated with the software. The first phase first linked augmented reality content and the first phase first linked virtual reality content is related to the first phase. In use, after beginning the first phase of the gameplay, the user orients the mobile device such that the camera lens is directed toward the map member 12. When the first phase first image target is recognized by the software, the first phase first linked augmented reality content (e.g., a building) is displayed on the mobile device and then the first phase first linked virtual reality content is displayed on the mobile device. The first phase first linked virtual reality content may only be displayed on the mobile device after a predetermined period of time. The user views the first phase first linked augmented reality content (e.g., a building) followed by the first phase first linked virtual reality content (a video) on a screen of the mobile device. The first phase first linked virtual reality content includes a first phase first video clue 39. In other words, the video includes a clue (e.g., the clue may be the words written on the hood of the car in FIG. 6). Next, the user enters information about the first phase first video clue into a text prompt box related to the software. If the information about the first phase first video clue is correct, the game play experience advances to the second phase of the plurality of phases.

The kit or gameplay experience may also include a first phase first printed evidence member that includes a first phase first printed clue 37 (e.g., the 555-5555 phone number on the drink coaster in FIG. 1). The method may include entering information about the first phase first video clue 39 (e.g., the words on the hood in FIG. 6) and the first phase first printed clue 37 (e.g., the phone number on the drink coaster evidence member 16 in FIG. 1) into the text prompt box 35. If the information about the first phase first video clue 39 and the first phase first printed clue 37 is correct, the game play experience advances to the second phase of the plurality of phases.

The map member 12 may include a second phase first image target (e.g., one of the image targets that is not activated or recognized during the first phase, but is activated or recognized during the second phase) that includes second phase first linked augmented reality content and second phase first linked virtual reality content. It will be appreciated that the second phase first image target is not recognized by the software during the first phase. In use, the gameplay may include orienting the mobile device 18 such that the camera lens 34 is directed toward the map member 12, the second phase first image target 40 is recognized by the software and the second phase first linked augmented reality content 38 is displayed on the mobile device and then the second phase first linked virtual reality content (i.e., video) is displayed on the mobile device.

Preferably, the kit includes a second phase first scannable evidence member 16 and the method includes orienting the mobile device such that the camera lens is directed toward the second phase first scannable evidence member. If the second phase first scannable evidence member is correct, the game play experience advances to a third phase of the plurality of phases.

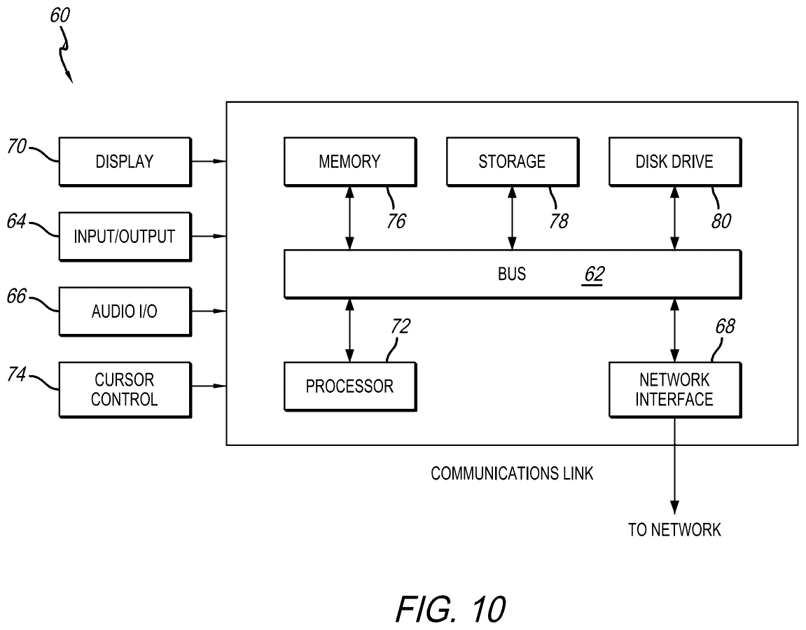

FIG. 10 is a block diagram of a computer system 60 (e.g., mobile device 18 or a head mounted device that includes the computer system built in) suitable for implementing one or more components discussed herein according to one embodiment of the subject matter of the present disclosure. In various implementations, mobile device 18 of the user may comprise a personal computing device (e.g., smart phone, a computing tablet, a personal computer, laptop, PDA, Bluetooth device, key FOB, badge, etc.) capable of communicating with the network. In an embodiment of the invention where the VR/AR assembly is implemented in a single head mounted device or HMD 14, HMD 14 may comprise a personal computing device incorporated into a pair of glasses or a helmet. HMD 14 may comprise or implement a plurality of hardware components and/or software components that operate to perform various methodologies in accordance with the described embodiments. Exemplary HMD 14 may include, for example, stand-alone and networked computers running mobile OS.

Computer system 60 includes a bus 62 or other communication mechanism for communicating information data, signals, and information between various components of computer system 60. Components include an input/output (I/O) component 64 that processes a user action, such as selecting keys from a virtual keypad/keyboard, selecting one or more buttons or links, etc., and sends a corresponding signal to bus 62. I/O component 64 may also include an output component such as a display medium 70 mounted a short distance in front of the user's eyes, and an input control such as a cursor control 74 (such as a virtual keyboard, virtual keypad, virtual mouse, etc.). An optional audio input/output component 66 may also be included to allow a user to use voice for inputting information by converting audio signals into information signals. Audio I/O component 66 may allow the user to hear audio. A transceiver or network interface 68 transmits and receives signals between computer system 60 and other devices, such as another user device, or another network computing device via a communication link to a network. In one embodiment, the transmission is wireless, although other transmission mediums and methods may also be suitable. A processor 72, which can be a micro-controller, digital signal processor (DSP), or other processing component, processes these various signals, such as for display on computer system 60 or transmission to other devices via communication link. Processor 72 may also control transmission of information, such as cookies or IP addresses, to other devices.

Components of computer system 60 also include a system memory component 76 (e.g., RAM), a static storage component 78 (e.g., ROM), and/or a disk drive 80. Computer system 60 performs specific operations by processor 72 and other components by executing one or more sequences of instructions contained in system memory component 76. Logic may be encoded in a computer readable medium, which may refer to any medium that participates in providing instructions to processor 72 for execution. Such a medium may take many forms, including but not limited to, non-volatile media, volatile media, and transmission media. In various implementations, non-volatile media includes optical, or magnetic disks, or solid-state drives; volatile media includes dynamic memory, such as system memory component 76; and transmission media includes coaxial cables, copper wire, and fiber optics, including wires that comprise bus 62. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 60. In various other embodiments of the present disclosure, a plurality of computer systems 60 coupled by communication link to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

Although embodiments of the present disclosure have been described, these embodiments illustrate but do not limit the disclosure. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method of participating in a game play experience that includes a plurality of phases to reach an objective, the method comprising the steps of:
(a) obtaining a kit that includes a map member, a first phase first printed evidence member, and wherein the map member includes at least a first phase first image target that includes first phase first linked augmented reality content and first phase first linked virtual reality content,
(b) obtaining a mobile device that includes software running thereon that is in communication with a target database, wherein the first phase first linked augmented reality content and the first phase first linked virtual reality content is associated with the software, wherein the mobile device includes a camera that has a camera lens, and wherein the first phase first linked augmented reality content and the first phase first linked virtual reality content is related to the first phase,
(c) beginning the first phase,
(d) orienting the mobile device such that the camera lens is directed toward the map member, wherein when the first phase first image target is recognized by the software, the first phase first linked augmented reality content is displayed on the mobile device and then the first phase first linked virtual reality content is displayed on the mobile device, and
(e) viewing the first phase first linked augmented reality content followed by the first phase first linked virtual reality content on a screen of the mobile device, wherein the first phase first linked virtual reality content includes a first phase first video clue,
(f) entering the first phase first video clue into a text prompt box related to the software, wherein the game play experience advances to the second phase of the plurality of phases.

2. The method of claim 1 wherein the first phase first printed evidence member includes a first phase first printed clue, and wherein step (f) includes entering the first phase first video clue and the first phase first printed clue into the text prompt box, wherein the game play experience advances to the second phase of the plurality of phases.

3. The method of claim 1 wherein the map member includes a second phase first image target that includes second phase first linked augmented reality content and second phase first linked virtual reality content, wherein the second phase first image target is not recognized by the software during the first phase.

4. The method of claim 3 further comprising the steps of orienting the mobile device such that the camera lens is directed toward the map member, wherein the second phase first image target is recognized by the software and the second phase first linked augmented reality content is displayed on the mobile device and then the second phase first linked virtual reality content is displayed on the mobile device.

5. The method of claim 1 wherein the kit includes a second phase first scannable evidence member, wherein the method further comprises orienting the mobile device such that the camera lens is directed toward the second phase first scannable evidence member, wherein if the second phase first scannable evidence member is correct, the game play experience advances to a third phase of the plurality of phases.

6. The method of claim 1 wherein the map member includes a scope member image target that includes scope member linked augmented reality content that shows a scope member on the mobile device, wherein step (e) includes positioning the scope member on the first phase first linked augmented reality content, wherein after the scope member has been positioned on the first linked augmented reality content for a predetermined period of time, the first phase first linked virtual reality content is displayed on the screen of the mobile device.

7. A virtual and augmented reality system comprising:
a kit that includes a map member, at least a first printed evidence member, and at least a first scannable evidence member, and wherein the map member includes at least a first phase first image target and a second phase first image target, and
software that is configured to run on a mobile device that includes a camera that has a camera lens, wherein the software is in communication with a target database, wherein the software includes first phase first linked augmented reality content that is associated with the first phase first image target and first phase first linked virtual reality content that is associated with the first phase first image target, wherein the first phase first linked virtual reality content includes a first phase first video clue, wherein the software includes second phase first linked augmented reality content that is associated with the second phase first image target and second phase first linked virtual reality content that is associated with the second phase first image target, wherein the second phase first linked virtual reality content includes a second phase first video clue.

8. The virtual and augmented reality system of claim 7 wherein the first printed evidence member includes a second phase first printed clue, wherein third phase first linked augmented reality content and third phase first linked virtual reality content is only accessible after entering the second phase first printed clue into a text prompt box related to the software.

9. The virtual and augmented reality system of claim 7 wherein third phase first linked augmented reality content and the third phase first linked virtual reality content is only accessible after scanning the first scannable evidence member using the camera.
